(19) United States
(12) Patent Application Publication
(10) Pub. No.: US 2026/0243615 A1
(43) Pub. Date: Aug. 20, 2026

(54) STRAIN GAUGE, STRAIN MEASUREMENT DEVICE, AND STRAIN MEASUREMENT METHOD

(71) Applicant: RESEARCH INSTITUTE FOR ELECTROMAGNETIC MATERIALS, TOMIYA-SHI, MIYAGI (JP)

(72) Inventors: Nobukiyo KOBAYASHI, TOMIYA-SHI, MIYAGI (JP); Yui HASEGAWA, TOMIYA-SHI, MIYAGI (JP); Kenji IKEDA, TOMIYA-SHI, MIYAGI (JP); Tadayoshi IWASA, TOMIYA-SHI, MIYAGI (JP); KenIchi ARAI, TOMIYA-SHI, MIYAGI (JP); Hiroshi MASUMOTO, SENDAI- SHI, MIYAGI (JP)

(21) Appl. No.: 19/164,271

(22) PCT Filed: May 24, 2024
(86) PCT No.: PCT/JP2024/019294

§ 371 Date: Sep. 11, 2025

(30) Foreign Application Priority Data
May 30, 2023 (JP) 2023-088294

(51) Int. Cl. G01L 1/22; H01C 10/10

(52) U.S. Cl. CPC G01L 1/2287; G01L 1/2262; H01C 10/103

(57) ABSTRACT

A nano-granular structure film constituting resistor 2 formed on one main surface of substrate 1 of a strain gauge is constituted of a nano-granular structure film which has composition represented by a general formula L_{100-a-b-c}MₐF_{b}O_{c} (L is one or more nonmagnetic metal elements or magnetic metal elements; M is one or more elements selected from Li, Mg, Al, Ca, Sr, Ba, Gd, and Y; F is fluorine; O is oxygen; and 12.0≤a≤33.0, 17.0≤b≤70.0, 0≤c≤1.0, 50.0≤a+b+c≤90.0), and in which metal particles represented by L and having an average particle diameter of 1.0 to 5.0 nm are distributed in insulating matrix formed of a fluoride of M or a fluoride and an oxide of M at an average interval between particles of 0.2 to 0.6 nm.

### TECHNICAL FIELD

The present invention relates to a technique of measuring strain of an object.

### BACKGROUND ART

In response to deformation of a nano-granular structure film including nanometer-sized metal particles dispersed in a fluoride matrix, such a phenomenon that an interval between the metal particles changes to thereby change electrical conductivity of the nano-granular structure film has been reported (see, for example, Non-Patent Literature 1).

### CITATION LIST

### Non Patent Literature

Non Patent Literature 1: S. Kaji, G. Oomi, S. Mitani, S. Takahashi, K. Takanashi, and S. Maekawa, Phys. Rev. B68, 054429 (2003)
Non Patent Literature 2: S. Mitani, S. Takahashi, K. Takanashi, K. Yakushiji, S. Maekawa, and H. Fujimori, Phys. Rev. Lett. 81, 2799 (1998)

### SUMMARY OF INVENTION

### Technical Problem

However, the above-described phenomenon occurs at an extremely low temperature near a liquid helium temperature, and therefore practical application of products or the like that uses the above-described phenomenon is difficult.

Therefore, an object of the present invention is to provide a strain gauge that can achieve improvement of practicality.

### Solution to Problem

A strain gauge of a first aspect of the present invention is a strain gauge including a substrate and a resistor formed on a surface of the substrate, wherein the resistor is constituted of a nano-granular structure film which has a composition represented by a general formula L_{100-a-b-c}MₐF_{b}O_{c} (L is one or more nonmagnetic metal elements selected from Pt, Au, Ag, and Cu; M is one or more elements selected from Li, Mg, Al, Ca, Sr, Ba, Gd, and Y; F is fluorine; O is oxygen; and 12.0≤a≤33.0, 17.0≤b≤70.0, 0≤c≤1.0, 50.0≤a+b+c≤90.0), and in which metal particles represented by L and having an average particle diameter of 1.0 to 5.0 nm are distributed in an insulating matrix formed of a fluoride of M or a fluoride and an oxide of M at an average interval between particles of 0.2 to 0.6 nm.

A strain gauge of a second aspect of the present invention is a strain gauge including a substrate and a resistor formed on a surface of the substrate, wherein the resistor is constituted of a nano-granular structure film which has a composition represented by a general formula L_{100-a-b-c}MₐF_{b}O_{c} (L is one or more magnetic metal elements selected from Fe, Co, and Ni; M is one or more elements selected from Li, Mg, Al, Ca, Sr, Ba, Gd, and Y; F is fluorine; O is oxygen; and 12.0≤a≤33.0, 17.0≤b≤70.0, 0≤c≤1.0, 50.0≤a+b+c≤90.0), and in which metal particles represented by L and having an average particle diameter of 1.0 to 5.0 nm are distributed in an insulating matrix formed of a fluoride of M or a fluoride and an oxide of M at an average interval between particles of 0.2 to 0.6 nm.

### Advantageous Effects of Invention

According to each of the strain gauges of the first aspect and the second aspect of the present invention, when a nano-granular structure film constituting the resistor is deformed, an interval between metal particles constituting the nano-granular structure film changes. This changes the thickness of a tunnel barrier between the particles and changes electrical conductivity. In this case, when the band gap of a matrix substance that forms the tunnel barrier is high, electrical resistivity of the whole film is increased, a high electrical resistivity, which is almost similar to that in the extremely low region as described in Non Patent Literature 1, is exhibited even at room temperature, and electrical conduction is achieved even at normal temperature due to the high-order tunneling as described in Non Patent Literature 2, resulting in improvement of the gauge rate of the strain gauge and therefore improvement of its practicality.

Furthermore, since in the strain gauge of the second aspect of the present invention, the metal particles constituting the nano-granular structure film are magnetic metal particles, the tunnel magnetoresistance effect (TMR) occurs as described in Non Patent Literatures 1 and 2. Moreover, when strain is applied to the strain gauge, the manifestation aspect of the TMR differs in response to a change in the interval between the metal particles depending on deformation of the nano-granular structure film. In the conventional materials as shown in Non Patent Literatures 1 and 2, the high-order tunneling occurs only at an extremely low temperature near the liquid helium temperature. However, in the strain gauge of the second aspect of the present invention, the high-order tunneling occurs at room temperature, resulting in further improvement of the gauge rate based on a change in the TMR in the presence of a magnetic field even at normal temperature and therefore further improvement of its practicality.

### BRIEF DESCRIPTION OF DRAWINGS

FIG. 1 shows a configuration explanation diagram of a strain gauge as embodiments of the first aspect and the second aspect of the present invention.

FIG. 2 shows an explanation view of a microstructure of a resistor.

FIG. 3 shows an explanation view of a relationship between an atomic ratio a+b+c of a resistor of the first aspect of the present invention and a gauge rate of a strain gauge.

FIG. 4 shows an explanation view of a relationship between an atomic ratio a+b+c of the second aspect of the present invention and a change in a TMR ratio due to application of strain.

### DESCRIPTION OF EMBODIMENTS

### First Embodiment

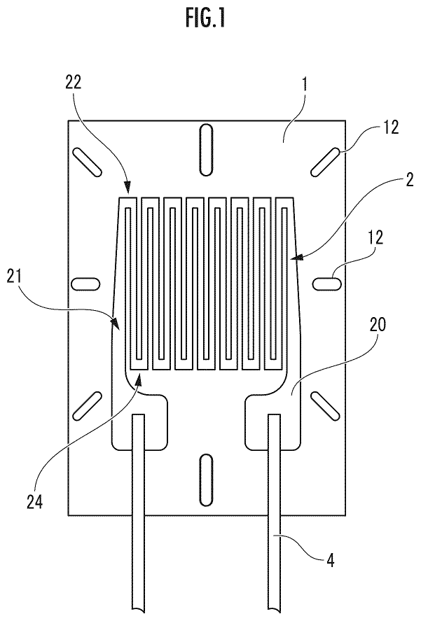

The strain gauge as an embodiment of the present invention shown in FIG. 1 includes a substrate 1 and a resistor 2.

The substrate 1 is composed of an insulating material having a flexibility such as glass, quartz glass, an Si wafer having an oxidized surface, an epoxy resin, or the like, and is formed into, for example, an almost rectangular plate. In addition, the substrate 1 is composed of a metal, an insulating thin film including a polyimide, an oxide such as Al₂O₃, a fluoride such as MgF₂, an epoxy resin, or the like may be formed on at least one main surface thereof. One main surface of the substrate 1 is provided with a reference mark 12 (such as center mark) that serve as a reference of the position and orientation of the strain gauge (resistor 2).

The resistor 2 is formed on one main surface of the substrate 1, and is composed of a nano-granular structure film having a predetermined gauge pattern. For example, as shown in FIG. 1, the resistor 2 includes a plurality of straight parts 21 that extend almost linearly in the longitudinal direction of the substrate 1 while the resistor 2 is folded at a distal folded tab 22 and a proximal folded tab 24 from one gauge tab 20 to the other gauge tab 20. A pair of gauge leads 4 are each connected to a pair of gauge tabs 20. The gauge pattern of the resistor 2 may be variously modified.

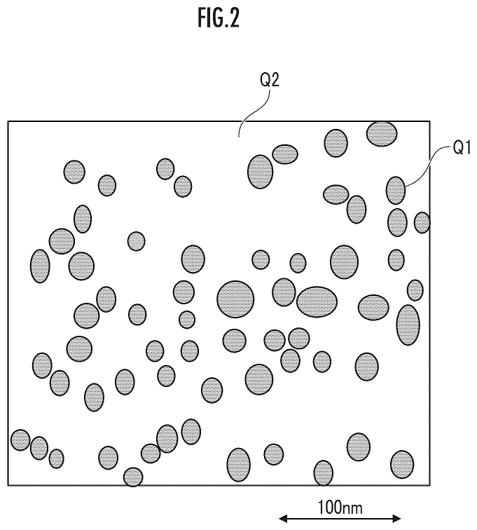

As schematically shown in FIG. 2, the resistor 2 is composed of a nano-granular structure film, in which nanometer-sized metal particles Q1 are almost uniformly dispersed and positioned in an insulating matrix Q2. The thickness of the nano-granular structure film is, for example, 0.1 to 10.0 μm.

The nano-granular structure film has a composition represented by a general formula L_{100-a-b-c}MₐF_{b}O_{c} (L is one or more metal elements; M is one or more elements selected from Li, Mg, Al, Ca, Sr, Ba, Gd, and Y; F is fluorine; O is oxygen; and 12.0≤a≤33.0, 17.0≤b≤70.0, 0≤c≤1.0, 50.0≤a+b+c≤90.0). The metal particles Q1 have an average particle diameter of 1.0 to 5.0 nm, and are distributed in the insulating matrix Q2 formed of a fluoride of M or a fluoride and an oxide of M at an average interval between particles of 0.2 to 0.6 nm.

In the first embodiment, the metal particles Q1 are one or more metal particles selected from Pt, Au, Ag, and Cu.

The other main surface of the substrate 1 may be provided with an insulating protective layer or protective film (for example, SiO₂, Al₂O₃, or the like) to cover the resistor 2.

### (Production Method)

A film of the resistor 2 constituting the strain gauge is formed on one main surface of the substrate 1 by using the sputtering method or an RF sputtering film formation apparatus. A target of at least one or more nonmagnetic metal elements of Pt, Au, Ag, and Cu and a target of a fluoride (or a fluoride and an oxide) of one or more elements selected from Li, Mg, Al, Ca, Sr, Ba, Gd, and Y are sputtered at the same time. The composition of the resistor 2 is adjusted by the ratio of the area, the number, or the like of a chip of Pt, Au, Ag, or Cu positioned on the target facing the substrate 1. This makes it possible to obtain a nano-granular structure film, in which nanometer-sized metal particles are dispersed in a matrix formed of a fluoride.

An Ar gas or a mixed gas of Ar and O₂ (0.1 to 10%) is used for the sputtering film formation. The film thickness is controlled by increasing or decreasing the time of film formation, to form a film having a film thickness of about 0.3 to 5.0 [μm]. The substrate is indirectly water-cooled, or is controlled to an optional temperature of the temperature range of 100 to 800 [° C.]. The sputtering pressure at the film formation is controlled to 1 to 60 [mTorr]. The sputtering electric power is adjusted within a range of 50 to 350 [W].

### Second Embodiment

The strain gauge as the second embodiment of the present invention includes the substrate 1 and the resistor 2, which is similar to the strain gauge as the first embodiment of the present invention (see FIG. 1). In addition, the resistor 2 is composed of a nano-granular structure film, in which the nanometer-sized metal particles Q1 are almost uniformly dispersed and positioned in the insulating matrix Q2 (see FIG. 2). The thickness of the nano-granular structure film is, for example, 0.1 to 10.0 μm.

The nano-granular structure film has a composition represented by the general formula L_{100-a-b-c}MₐF_{b}O_{c} (L is one or more metal elements; M is one or more elements selected from Li, Mg, Al, Ca, Sr, Ba, Gd, and Y; F is fluorine; O is oxygen; and 12.0≤a≤33.0, 17.0≤b≤70.0, 0≤c≤1.0, 50.0≤a+b+c≤90.0). The metal particles Q1 have an average particle diameter of 1.0 to 5.0 nm, and are distributed in the insulating matrix Q2 formed of a fluoride of M or a fluoride and an oxide of M at an average interval between particles of 0.2 to 0.6 nm.

The second embodiment is different from the first embodiment because the metal particles Q1 are one or more magnetic metal particles selected from Fe, Co, and Ni.

The strain gauge of the second embodiment is produced in the same manner as in the strain gauge of the first embodiment.

### EXAMPLES

As the substrate 1, SiO₂ (synthetic quartz) or alkali-free glass substrate measuring 10 to 50 mm in length, 10 to 50 mm in width, and 0.5 to 1.0 mm in thickness was employed. As the resistor 2 having a composition represented by a compositional formula represented by L_{100-a-b-c}MₐF_{b}O_{c} on one main surface of the substrate 1, a nano-granular thin film, which had the configuration shown in FIG. 1 and had a thickness of 1.0 to 3.0 μm, was formed. As a result, the strain gauge of Example was produced.

Table 1 summarizes and shows the configurations of nano-granular thin films constituting strain gauges of Example 1 to 10 produced according to the first embodiment and the gauge rates of the above-described strain gauges. Table 1 also shows the configuration of a nano-granular thin film constituting a strain gauge of Comparative Example 1 and the gauge rate of the above-described strain gauge.

TABLE 1

| | | | Average | |
|---|---|---|---|---|
| | | Average | interval | |
| | | particle | between | |
| | Composition | diameter | particles | Gauge |
| | [at. %] | [nm] | [nm] | rate |
| Example 1 | Au_{31.6} Mg_{20.8} F_{47.6} | 3.75 | 0.32 | 11.7 |
| Example 2 | Au_{30.5} Ca_{20.3} F_{49.2} | 3.67 | 0.34 | 11.8 |
| Example 3 | Cu_{40.1} Ba_{17.8} F_{42.1} | 4.01 | 0.29 | 8.5 |
| Example 4 | Cu_{10.5} Sr_{27.1} F_{62.4} | 1.52 | 0.54 | 4.3 |
| Example 5 | Pt_{10.4} Mg_{28.2} F_{61.4} | 1.62 | 0.52 | 3.1 |
| Example 6 | Pt_{20.6} Ba_{24.8} F_{54.6} | 2.82 | 0.41 | 7.9 |
| Example 7 | Cu_{21.5} Ag_{5.7} ST_{22.4} F_{50.4} | 3.62 | 0.37 | 8.8 |
| Example 8 | Au_{6.2} Pt_{4.2} Y _{15.3} Li_{6.1} F_{68.2} | 1.58 | 0.53 | 4.47 |
| Example 9 | Au_{29.3} Pt_{6.2} Mg_{26.7} Al_{5.6} | 4.08 | 0.28 | 5.48 |
| | F_{32.2} | | | |
| Example 10 | AU_{33.3} Mg_{22.0} F_{43.7} O_{1.0} | 3.88 | 0.31 | 9.28 |
| Comparative | Fe_{30.1} Co_{20.0} Mg_{10.2} F_{39.7} | 5.11 | 0.16 | 1.49 |
| Example 1 | | | | |

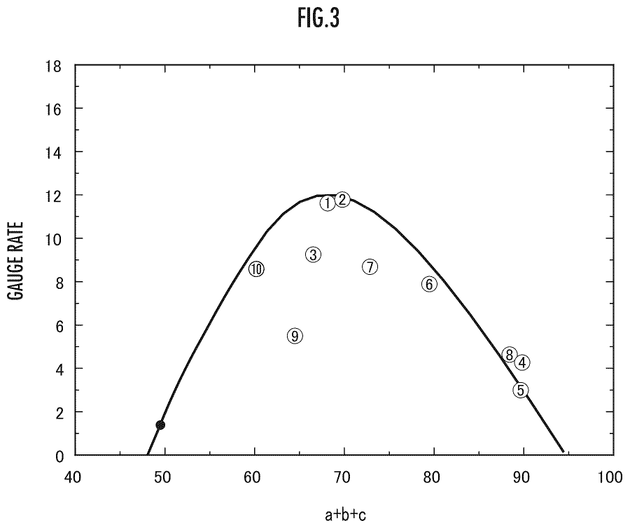

In FIG. 3, relationships between a+b+c of the resistor 2 and the gauge rates of the strain gauges under such a circumstance that no magnetic field is applied to each of the strain gauges of Examples 1 to 10 and Comparative Example 1 are shown by numbers corresponding to the numbers of the respective Examples enclosed within circles, and the filled circle. It is found from FIG. 3 that the strain gauges of Examples 1 and 2, in which a+b+c of the resistor 2 is near 70.0, exhibit the highest gauge rates. The a+b+c preferably falls within the range of 60.0 to 80.0 (see Examples 1, 2, 3, 6, 7, and 10). The a+b+c of less than 50.0 (see Comparative Example 1) or more than 90.0 is not preferable because its gauge rate is similar to or equal to or less than the gauge rate of the conventional material, Cu—Ni alloy.

Table 2 summarizes and shows the configurations of the granular thin films constituting the strain gauges of Examples 11 to 20 produced by the second embodiment, and TMR ratios in the case where no strain is applied to the above-described strain gauges and the case where strain is applied to the above-described strain gauges. The TMR ratios were measured under the condition in which a magnetic field of 1 T is applied. Regarding application of strain, the strain gauge of FIG. 1 was bonded to a strain body formed of stainless measuring 50 mm in width, 180 mm in length, and 1 mm in thickness, one end of the long side of the strain body was supported, the opposite end was compressed by 5 mm, to bend the strain gauge. At this time, the strain gauge has such a configuration that compressive stress acts. When tensile stress is applied, a size of a change in the TMR ratio is the same as the case where compressive strain is applied, but the sign is reversed.

TABLE 2

| | | | Average | | | TMR ratio |
|---|---|---|---|---|---|---|
| | | Average | interval | | TMR ratio | (with |
| | | particle | between | | (without | compression |
| | Composition | diameter | particles | Gauge | strain) | strain) |
| | [at. %] | [nm] | [nm] | rate | [%] | [%] |
| Example 11 | Fe_{13.0} Co_{10.2} Mg_{22.5} F_{54.3} | 3.02 | 0.39 | 7.8 | 13.7 | 14.8 |
| Example 12 | Fe_{15.2} Co_{11.4} Ba_{20.4} F_{53.0} | 3.69 | 0.36 | 9.5 | 12.9 | 13.9 |
| Example 13 | Co_{50.0} Ca_{13.7} F_{36.3} | 4.32 | 0.28 | 2.2 | 1.2 | 1.3 |
| Example 14 | Fe_{9.6} Co_{9.1} Sr_{25.1} F_{56.2} | 2.52 | 0.42 | 5.1 | 5.6 | 5.9 |
| Example 15 | Co_{45.0} Al_{12.7} F_{42.3} | 4.21 | 0.24 | 6.8 | 2.1 | 2.2 |
| Example 16 | Fe_{10.1} Co_{10.4} Y_{17.2} F_{62.3} | 2.82 | 0.41 | 7.7 | 7.9 | 8.4 |
| Example 17 | Fe_{12.2} Co_{10.2} Ni_{9.3} Gd_{15.8} F_{52.5} | 3.82 | 0.29 | 7.9 | 8.2 | 8.8 |
| Example 18 | Fe_{13.2} Co_{9.3} Ni_{11.5} Mg_{13.3} Li_{7.5} F_{45.2} | 3.99 | 0.31 | 11.5 | 6.3 | 6.7 |
| Example 19 | Fe_{23.1} Co_{15.2} Mg_{19.2} F_{41.5} O_{1.0} | 4.09 | 0.28 | 10.1 | 4.1 | 4.4 |
| Example 20 | Fe_{5.3} Co_{4.9} Mg_{24.9} F_{64.9} | 1.39 | 0.51 | 7.9 | 0.50 | 0.53 |

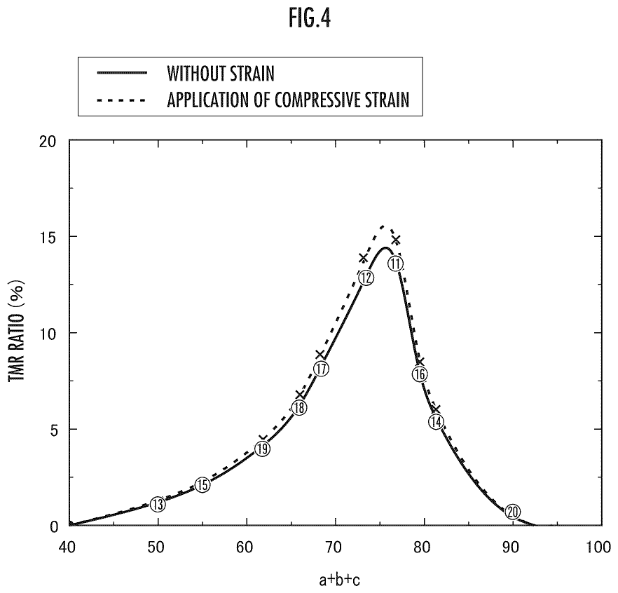

In FIG. 4, under such a circumstance that a magnetic field is applied to each of the strain gauges of Examples 11 to 20, relationships between a+b+c of the resistor 2 and the TMR ratios under the condition in which no strain is applied to the resistor 2 (without strain) are shown by numbers corresponding to the numbers of the respective Examples enclosed within circles. In FIG. 4, under such a circumstance that a magnetic field is applied to each of the strain gauges of Examples 11 to 20, relationships between a+b+c of the resistor 2 and the TMR ratios under the condition in which strain is applied to the resistor 2 (with strain) are shown by “x” plots near the above-described numbers enclosed within circles. In FIG. 4, some “x” plots are hidden by the numbers enclosed by circles and are not shown.

A difference between the TMR ratio without strain and the TMR ratio with strain is 1% or more, and the gauge rate, which is converted from the TMR ratio under the condition that a magnetic field is applied, is 20 or more, which is extremely larger than the gauge rate of the conventional material, Cu—Ni alloy. The a+b+c is preferably within the range of 50.0 to 90.0, which is the compositional region exhibiting a larger TMR ratio (see Examples 11 to 20), more preferably within the range of 65.0 to 85.0 (see Examples 11, 12, 14, 16, 17, and 18), and still more preferably within the range of 68.0 to 80.0 (see Examples 11, 12, 16, and 17). When the a+b+c is less than 50.0, or more than 90.0, the TMR does not appear or is very small, which is not preferable.

### REFERENCE SIGNS LIST

1 substrate
12 reference mark
2 resistor
20 gauge tab
21 straight part
22 distal folded tab
24 proximal folded tab
4 gauge lead
Q1 metal particles
Q2 insulating matrix.

1. A strain gauge comprising:
a substrate; and
a resistor formed on a surface of the substrate,
wherein the resistor is constituted of a nano-granular structure film which has a composition represented by a general formula L_{100-a-b-c}MₐF_{b}O_{c}, wherein L is one or more nonmagnetic metal elements selected from the group consisting of Pt, Au, Ag, and Cu or one or more magnetic metal elements selected from the group consisting of Fe, Co, and Ni; M is one or more elements selected from Li, Mg, Al, Ca, Sr, Ba, Gd, and Y; F is fluorine; O is oxygen; and 12.0≤a≤33.0, 17.0≤b≤70.0, 0≤c≤1.0, 50.0≤a+b+c≤90.0, and in which metal particles represented by L and having an average particle diameter of 1.0 to 5.0 nm are distributed in an insulating matrix formed of a fluoride of M or a fluoride and an oxide of M at an average interval between the particles of 0.2 to 0.6 nm.

2. (canceled)

3. A strain measurement device comprising:
the strain gauge according to claim 1;
a circuit component constituting a bridge circuit including the strain gauge; and
a magnet configured to apply a magnetic field to the strain gauge.

4. A strain measurement method comprising:
a step of attaching the strain gauge according to claim 1 to an object;
a step of applying a magnetic field to the strain gauge using a magnet; and
a step of detecting strain appearance of the object according to a change in electrical resistance of the strain gauge.
